(19) United States
(12) Patent Application Publication
(10) Pub. No.: US 2014/0202952 A1
(43) Pub. Date: Jul. 24, 2014

(54) MULTILAYER ANODIZED ALUMINIUM OXIDE NANO-POROUS MEMBRANE AND METHOD OF MANUFACTURE THEREOF

(71) Applicant: ASIAN INSTITUTE OF TECHNOLOGY, Klong Luang (TH)

(72) Inventors: Nitin Afzulpurkar, Klong Neung, Klong Luang, Pathumthani (TH); Ajab Khan Kasi, Quetta (PK)

(73) Assignee: ASIAN INSTITUTE OF TECHNOLOGY, Klong Luang (TH)

(21) Appl. No.: 13/748,242

(22) Filed: Jan. 23, 2013

(51) Int. Cl. B01D 67/00; B01D 71/02

(52) U.S. Cl. CPC B01D 67/0069; B01D 71/025
USPC 210/490; 205/75

(57) ABSTRACT

The present invention relates to a method of producing multilayer anodized aluminium oxide nano-porous membrane and the membrane produced thereof. Further the invention relates to the nano-porous multi-layer membrane for filtration application. The three layered membrane of the present invention avoids sticking of solute components on the surface obviating the problem of coagulation. This membrane imparts anti coagulation capability wherein in-spite of sticking of the solute component on the surface of the membrane appropriate passage is still available for liquid/small solutes to pass beneath the said stuck solute component to enhance effective surface area for filtration obviating the problem associated with coagulation.

### FIELD OF INVENTION

The present invention relates to a method of producing multilayer anodized aluminium oxide nano-porous membrane and the membrane produced thereof. Further the invention relates to the nano-porous multi-layer membrane for filtration application.

### BACKGROUND OF THE INVENTION

Membranes used for selective filtration of solute. One of such applications is dialysis wherein the permeability of the membrane is of paramount importance and is primarily a function of the pore diameter and membrane thickness. The diffusive transport of solutes is directly proportional to concentration gradient of solutes across the dialysis membrane and surface area, and inversely proportional to the membrane thickness. The effectiveness of such a membrane used in hemodialysis depends on the pore diameter. If pore diameter of the membrane is increased, the problem of blood component leakage is encountered. If thickness is reduced then the membrane does not withstand the pressure gradient. The convective transport depends on pressure gradient at two side of membrane and pore diameter. Fluid permeability of a membrane is directly proportional to the pore diameter and inversely proportional to the membrane thickness.

To enhance diffusive transport of solutes and fluid permeability multilayer AAO membrane is used. This membrane is fabricated in three layers, hence the name. The first layer is at the surface in the form of concave pits which has 100 μm to 300 nm diameter and about 100 nm in depth, in second layer pore diameter is 5 nm to 10 nm with about 200 nm depth, and third layer is hexagonal order of pores of desired diameter ranging from 15 nm to 80 nm which penetrate to the remaining thickness of membrane. The first layer stops the larger components of blood, and allows water and smaller components to reach second layer, the second layer filters water and small solutes, while the third layer due to its larger pores help to speed up hemodialysis. The conventional nano-porpous mutli-layer membrane predominantly comprises of two layers.

The US Patent Application number 2003/0047505 discloses a nanoporous tubular filter having membrane comprising branched pores formed by anodizing a section of metal tubing. The network extends from an inner wall of the filter to and through an outer exposed wall area of the membrane, and has a first layer of pores with a diameter greater than that of pores of an adjacent second layer. Further, the network is integral with an outer support matrix having been formed of an outer wall of the section of tubing by removing selected portions of the outer wall, thus leaving the exposed wall area of the membrane. The outer support matrix corresponds with a patterned area formed of an external-coat applied to the tubing's outer wall. An electroplating of a magnetostrictive material deposited on the outer support matrix or on an interior surface is adapted for use as a diffusion ON-OFF switch. The filter is adaptable for use as a hydrogen reactor whereby an electroplating of a catalyst material is deposited on at least a portion of the filter's inner wall. Also, a method for producing a nanoporous tubular filter that includes the steps of: applying an external-coat to an exterior surface of an outer wall of a section of metal tubing; anodizing the section of tubing at a first voltage for a first time-period then at a second voltage for a second time-period, a membrane produced thereby comprising a network of generally branched pores; and forming a patterned area to cover that portion of the outer wall that will form an outer support matrix. However, this suffers from drawback that it comprises of only two layers.

U.S. Pat. No. 7,396,382 discloses porous membrane for separation of carbon dioxide from a fluid stream at a temperature higher than about 200° C. with selectivity higher than Knudsen diffusion selectivity. The porous membrane comprises a porous support layer comprising alumina, silica, zirconia or stabilized zirconia; a porous separation layer comprising alumina, silica, zirconia or stabilized zirconia, and a functional layer comprising a ceramic oxide contactable with the fluid stream to preferentially transport carbon dioxide. The membrane suffers from the drawback that separate layers are fabricated in different processes independently and further these layers are joined with each other. This suffers from the drawback of complex process, scalability and mass production issues.

US patent application number 2010/0219079 discloses membranes including anodic aluminum oxide structures that are adapted for separation, purification, filtration, analysis, reaction and sensing. The membranes can include a porous anodic aluminum oxide (AAO) structure having pore channels extending through the AAO structure. The membrane may also include an active layer, such as one including an active layer material and/or active layer pore channels. The active layer is intimately integrated within the AAO structure, thus enabling great robustness, reliability, resistance to mechanical stress and thermal cycling, and high selectivity. Methods for the fabrication of anodic aluminum oxide structures and membranes are also provided.

This has only two layers. It suffers from the drawback that additional material is needed to be inserted in the membrane from bottom side to improve its filtration and mechanical stability. This is a very complex process and needs additional process step to insert the said material in the membrane. In this process rather than removing entire barrier layer, it is made thinner and pores are created in it. This process demands extremely precise control on the process parameters impeding the viability for mass production as well as repeatability of the process. This process may encounter undesirable removal of entire barrier causing failure of the membrane.

It is to be noted that in conventional methods predominately anodization voltage is controlled to control the pore size in the respective layers (mostly two layers). In these methods gradually anodization voltage is varied in a single step to obtain correspondingly varied pore sizes.

The conventional methods suffer from following drawbacks:
Only one channel through one concave surface on the membrane, this result in substantial reduction in effective area available for filtration of the membrane resulting in adverse effect on the membrane performance
Ineffective filtration in the event of sticking of a solute component on the surface of the membrane wherein since there is only single channel available per concave surface there is limitation on the filtration of smaller diameter solute particles as they pass through the said channel.
During the process of filtration, there is a strong possibility of larger diameter solute components to stick/stay on the membrane surface wherein smaller diameter particles can pass beneath the said larger diameter solute component. However since there is only one pore and channel per concave surface, these smaller diameter particles are not filtered and just pass through this channel resulting in coagulation problem.
Complex process of manufacture
Lack of more than two layers

There is need in the market place of a nano-porous multilayer membrane to avoid sticking of solute components on the surface of the membrane obviating the problem of coagulation. It is desirable to have a three layered membrane to impart anti coagulation capability wherein in-spite of sticking of the solute component on the surface of the membrane appropriate passage is still available for liquid/small solutes to pass beneath the said stuck solute component to enhance effective surface area for filtration obviating the problem associated with coagulation.

### SUMMARY OF INVENTION

The main object of the invention is to provide a method to manufacture a multi-layer nano-porous membrane. Further object of the invention is to provide a multi-layer nano-porous membrane.

Another object of the invention is to provide plurality of pores and corresponding channels per concave surface of the membrane.

Yet another object of the invention is to provide a membrane to obviate problems associated with sticking/staying of the larger diameter solute components on the surface of the membrane.

Another object of the invention is to provide a method to control pore sizes of the membrane in each of the layer to desired diameters in accordance with the end use of such membrane.

Another object of the invention is to provide a multi-layered membrane of three layers and a method to manufacture thereof.

Yet another object of the invention is to provide a method of manufacturing a multi-layer membrane to be used in dialysis and the membrane thereof.

Another object of the invention is to enhance mechanical strength of the said membrane.

Yet another object of the invention is to provide a multi-layered membrane for dialysis application to enable selective stopping of blood cells, selective filtration of undesired toxic substances such as urea and creatinine from blood and enhance flow rate and reduce resistance for flow.

Yet another object of the invention is to provide a multi-layered membrane for gas separation, virus separation, water filtration and dialysis applications.

Yet another object of the invention is to use a judicious combination of anodization and respective electrolytes to manufacture the said multi-layer membrane.

Another object of the invention is to provide a multi-layer membrane to enhance hemofiltration and hemodialysis processes.

Yet another object of the invention is to because the larger component of blood cannot approach the second layer of membrane. The smaller pores in second layer ensures that just the toxin substances such as urea and creatinine which are small in size can filter out from the blood while there is very less possibility of albumin to filter out from the blood.

Thus in accordance with the present invention, the method of preparing multi-layer nano-porous membrane comprises of
electro-polishing of the substrate,
combination of hard and mild anodization,
barrier layer removal.

The method comprises steps of:
Electro polishing of Aluminum substrate (Al) comprising steps of:
   placing the said Al in the mixture of perchloric acid and ethanol wherein the ratio of respective chemicals is in the range of 1:3 to 1:5 by volume wherein purity of ethanol is in the range of 99%-99.9% and that of Perchloric acid is in the range of 69-72%;
   Applying potential at a temperature less than 10° C. wherein the potential is in the range of 10 to 20 V;
   Applying potential for 3 to 10 min depending on the surface roughness
First step hard anodization comprising steps of:
   selecting electrolyte from either of oxalic acid, phosphoric acid, sulfuric acid and malunic acid wherein the concentration of the said acid depends on the pore size;
   gradual application of voltage from 20 V up to the final voltage that is in the range of 60 to 200 V wherein process time depends on the membrane thickness, it can range from 5 minutes to 20 minutes

Chemical etching of the anodized aluminum oxide comprising steps of: etching in chromic acid and phosphoric acid wherein the temperature is in the range of 65-80° C. wherein phosphoric acid is in the range of 6 wt % to 7 wt % and chromic acid is in the range of 2 wt % to 3 wt % wherein purity of Chromic acid is 99% and purity of phosphoric acid is 85%;

Upon etching AAO, hexagonal arrangement of concave surfaces appear on Al surface
Second step mild anodization comprising steps of:
   selecting electrolyte from either of oxalic acid, phosphoric acid, sulfuric acid and malunic acid wherein the concentration of the said acid depends on the pore size;
   applying a constant voltage directly to the final value (without gradually increasing it from 20 V as is the case in the said first step) that is lower than that in the first step anodization wherein the said final voltage is in the range of 20 to 195 V depending on the electrolyte and pore size.

Barrier layer is removed using voltage pulse method comprising steps of;
placing the said substrate in perchloric acid and ethanol with volume ratio in the range of 1:3 to 1:5 respectively;
applying a voltage pulse from 45 to 50 V for 3 to 5 seconds that causes to detach AAO from Al and remove BL.

### BRIEF DESCRIPTION OF THE DRAWINGS

Features and advantages of this invention will become apparent in the following detailed description and the preferred embodiments with reference to the accompanying drawings. The embodiments are illustrated by way of example and not by way of limitation in the figures of the accompanying drawings.

FIG. 1(a) and (b) illustrates schematic of the concave surface of the membrane.

FIG. 2(a) and (b) depicts the surface and cross sectional SEM image of the multilayer membrane of the present invention.

FIG. 3 depicts the SEM image of such the porous multi-layer membrane manufactured using two steps of hard anodization.

FIG. 4 depicts the SEM image of surface and cross section of the multi-layer membrane manufactured using different electrolytes.

FIG. 5 depicts the SEM image of the surface and cross section of the multi-lauer membrane manufactured using mild anodization in two steps but different electrolytes in both the steps.

### DESCRIPTION OF THE INVENTION

In the following description, various embodiments will be disclosed. However, it will be apparent to those skilled in the art that the embodiments may be practiced with only some or shall disclosed subject matter. For purposes of explanation, specific numbers, materials, and/or configuration are set forth in order to provide a thorough understanding of the embodiments. However, it will also be apparent to one skilled in the art that the embodiments may be practiced without one or more of the specific details, or with other approaches, materials, components etc. In other instances, well-known structures, materials, and/or operations are not shown and/or described in detail to avoid obscuring the embodiments. Accordingly, in some instances, features are omitted and/or simplified in order to not obscure the disclosed embodiments. Furthermore, it is understood that the embodiments shown in the Figures are illustrative representation and are not necessarily drawn to scale.

The nano-porous multi-layer membrane is produced using a combination of hot and mild anodization method. It is surprisingly found that in contrast with the conventional anodization methods wherein voltage is gradually varied in a single step, if the first step anodiation voltage is maintained higher value and further in the second step if voltage is maintained lower than that (in the first step), plurality of pores were generated in the each of the concave surface of the region and further sudden decrease in the pore size was observed (than that of gradual reduction of the pore diameter).

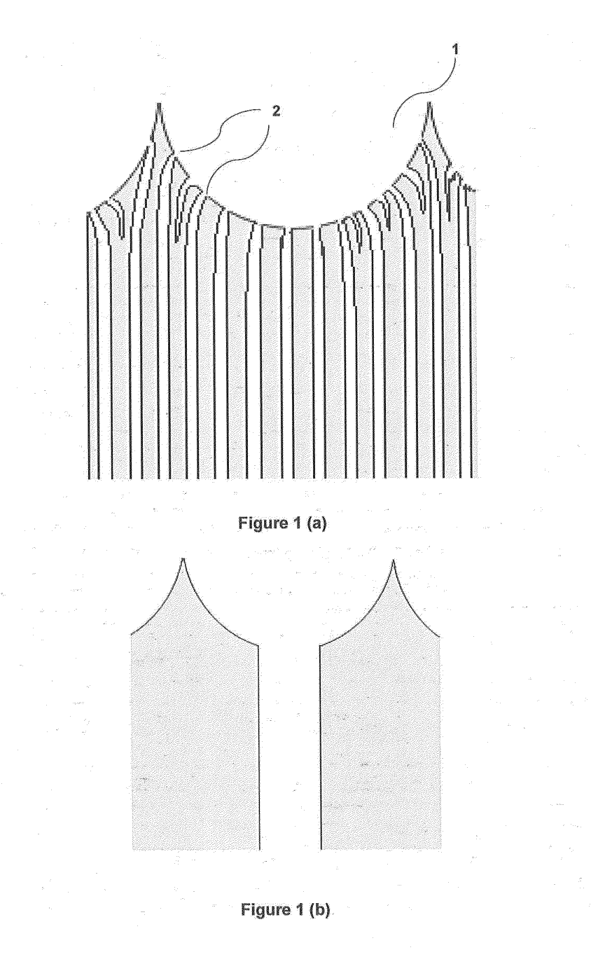

It is further observed that once such pores are generated, there is propagating increase (towards the bottom of the membrane) in the pore diameter and further retaining constant pore diameter while same (as maintained in the second step) anodization voltage is maintained. This phenomenon is depicted in a schematic FIG. 1. One of the concave surfaces 1 on the membrane is represented for illustration purpose. It can be observed that plurality of pores 2 are generated on the said concave surface 1 further leading to channels.

The method of preparing multi-layer nano-porous membrane comprises steps of
electro-polishing of the substrate,
combination of hard and mild anodization,
barrier layer removal.

The process of electro polishing of Aluminum substrate (Al) comprises steps of:
placing the said Al in the mixture of perchloric acid and ethanol wherein the ratio of respective chemicals is in the range of 1:3 to 1:5 by volume wherein purity of ethanol is in the range of 99%-99.9% and that of Perchloric acid is in the range of 69-72%;
applying potential at a temperature less than 10° C. wherein the potential is in the range of 10 to 20 V;
applying potential for 3 to 10 min depending on the surface roughness.

First step hard anodization process comprises steps of:
selecting electrolyte from either of oxalic acid, phosphoric acid, sulfuric acid and malunic acid wherein the concentration of the said acid depends on the pore size;
gradual application of voltage from 20 V up to the final voltage that is in the range of 60 to 200 V wherein process time depends on the membrane thickness, it can range from 5 minutes to 20 minutes.

Chemical etching of the anodized aluminum oxide comprises a step of etching in chromic acid and phosphoric acid wherein the temperature is in the range of 65-80° C. wherein phosphoric acid is in the range of 6 wt % to 7 wt % and chromic acid is in the range of 2 wt % to 3 wt % wherein purity of Chromic acid is 99% and purity of phosphoric acid is 85%.

Upon etching AAO, hexagonal arrangements of plurality of concave surfaces appear on Al surface. Further plurality of pores appear in the said concave surface.

The Second step mild anodization comprises steps of:
selecting electrolyte from either of oxalic acid, phosphoric acid, sulfuric acid and malunic acid wherein the concentration of the said acid depends on the pore size;
applying a constant voltage directly to the final value (without gradually increasing it from 20 V as is the case in the said first step) that is lower than that in the first step anodization wherein the said final voltage is in the range of 20 to 195 V depending on the electrolyte and pore size.

Barrier layer (BL) is removed using voltage pulse method comprising steps of;
placing the said substrate in perchloric acid and ethanol with volume ratio in the range of 1:3 to 1:5 respectively;
applying a voltage pulse from 45 to 50 V for 3 to 5 seconds that causes to detach AAO from Al and remove BL.

The parameter values of the said first step hard anodization and second step mild anodizationas well as electrolyte are varied. It is to be noted that the electro-polishing and barrier removal process is same as described above in all the following embodiments, hence it is not repeated therein. Following are various embodiments of the invention.

In the first embodiment
the said first step anodization is performed at 120 to 130V in oxalic acid as electrolyte for 5 to 10 min depending on the size of the substrate;
etching is carried out in chromic acid and phosphoric acid wherein the temperature is in the range of 65-80° C.; preferably phosphoric acid is in the range 6 wt % to 7 wt % and chromic acid is in the range of 2 wt % to 3 wt % wherein preferably purity of Chromic acid is 99% and purity of phosphoric acid is 85%;
upon etching hexagonal arrangement of concave surfaces appeared on Al surface;
plurality of small pores initiated in each of the concave surface;
the said second step mild anodization is performed at 40 to 45 V using the same electrolyte as used in the first step anodization.

The barrier layer is removed by one of the following two methods:

1) Chemical etching comprising steps of:
etching the substrate in saturated mercuric chloride so as to separate anodized aluminum oxide from Al;
placing of AAO in 5 wt % Phosphoric acid for about 35 to 40 min at 31° C. to 32° C. for etching of BL.
   2) Voltage pulse detachment comprising steps of:
placing anodized aluminum substrate in Perchloric acid and ethanol with volume ratio from 1:3 to 1:5 respectively,
applying a voltage pulse from 45 to 50 V for 3 to 5 s which causes detachment of AAO from Al and remove BL.

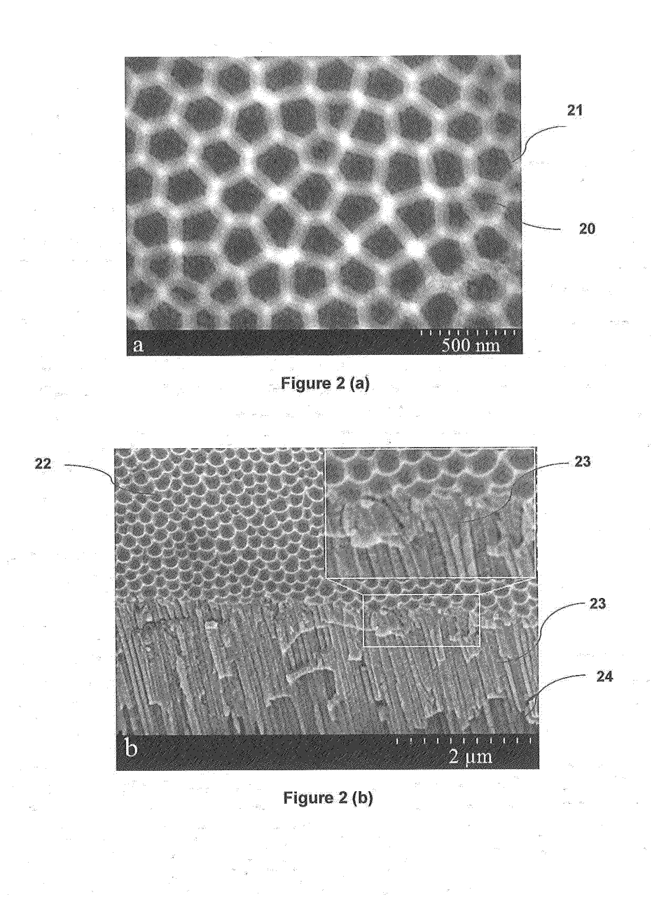

The initial diameter of pores in second step of anodization is in the range of 5 nm to 10 nm. The pores diameter increased after covering a distance of about 200 nm. Here average pore diameter is 35 nm. It is to be noted that the surface layer of concave surface is the first layer, the initial small pore diameter as second layer and the extended larger pores as third layer. This is illustrated in the FIG. 2 using this non-limiting example. The surface SEM image of multilayer membrane manufactured using this method is depicted in FIG. 2a. This image clearly depicts the first and second layer of membrane 21 and 22 respectively. The cross-sectional SEM image of multilayer AAO membrane of this embodiment is depicted in FIG. 2(b). The plurality of concave surfaces 22 are observed on the membrane surface. The magnified form of the rectangular indicated portion in the image depicts bending of AAO nanochannels of higher diameter 23 in the second layer followed by substantially parallel and straight nanochannels 24 in the third layer.

In the second embodiment hard anodization is carried out in both the steps. The electro polishing and barrier layer removal is carried out in accordance with the process already mentioned above. The anodization process comprises steps of:
the said first step anodization is performed at voltage in the range of 120 to 130V in oxalic acid as electrolyte for 5 to 10 min;
etching is carried out in chromic acid and phosphoric acid;
upon etching hexagonal arrangement of concave surfaces appeared on Al surface wherein the depth of this layer is about 100 nm;
plurality of small pores initiated in each of the concave surface;
the said second step hard anodization is performed at 100 to 110V using same electrolyte as used in the first step anodization wherein average diameter of pore is 25 nm;
further, pores diameter is increased as nanochannels proceed by few nanometers wherein in third layer diameter is about 80 nm in one of the preferred variants

The barrier layer is removed by one of the following two methods

1) Chemical etching which comprises of
etching the substrate in saturated mercuric chloride so as to separate anodized aluminum oxide from Al;
placing of AAO in 5 wt % Phosphoric acid for about 35 to 40 min at 31° C. to 32° C. for etching of BL
   2) Voltage pulse detachment comprising steps of:
placing anodized aluminum sample in perchloric acid and ethanol with volume ratio from 1:3 to 1:5 respectively;
applying a voltage pulse from 115 to 120 V for 3 to 5 s which causes to detach AAO from Al and remove BL.

In the third embodiment:

A combination of hard and mild anodization is used with different electrolytes. The first step hardanodization is carried out at voltage selected in the range of 120 to 130 V in oxalic acid and second step in sulfuric acid wherein voltage is selected in the range of 20 to 25 V. The processes of elector-polishing and barrier layer removal are followed as already described above.

In the fourth embodiment:

Mild anodization is used in both the steps, however the electrolytes used are different in both the steps. The first step mild anodization is performed at a voltage in the range of 40 to 45V in oxalic acid and second step at a voltage selected in the range of 20 to 25 V in sulfuric acid. Three layered membrane is formed with first layer concave surface diameter 100 nm, second layer pore diameter about 5 nm and third layer pores diameter about 15 nm.

### Example 1

The nano-porous mutli-layer membrane is prepared In accordance with the said second embodiment hard anodization is carried out in both the steps. Electro-polishing and barrier layer removal processes were carried out as described above. The two steps of hard anodization comprised steps of:
the said first step anodization is performed at a voltage selected in the range of 120 to 130V in oxalic acid as electrolyte for 5 to 10 min wherein etching is carried out in chromic acid and phosphoric acid wherein the temperature is in the range of 65-80° C. wherein preferably 6 wt % phosphoric acid and chromic acid is 2 wt %. wherein purity of Chromic acid is 99% and purity of phosphoric acid is 85%;
upon etching hexagonal arrangement of concave surfaces appeared on Al surface wherein the depth of this layer is about 100 nm;
plurality of small pores initiated in each of the concave surface;
the said second step hard anodization is performed at 100 to 110 V using same electrolyte as used in the first step anodization wherein average diameter of pore is 25 nm;
further, pores diameter is increased as nanochannels forwarded by few nanometers wherein in third layer diameter is about 80 nm.

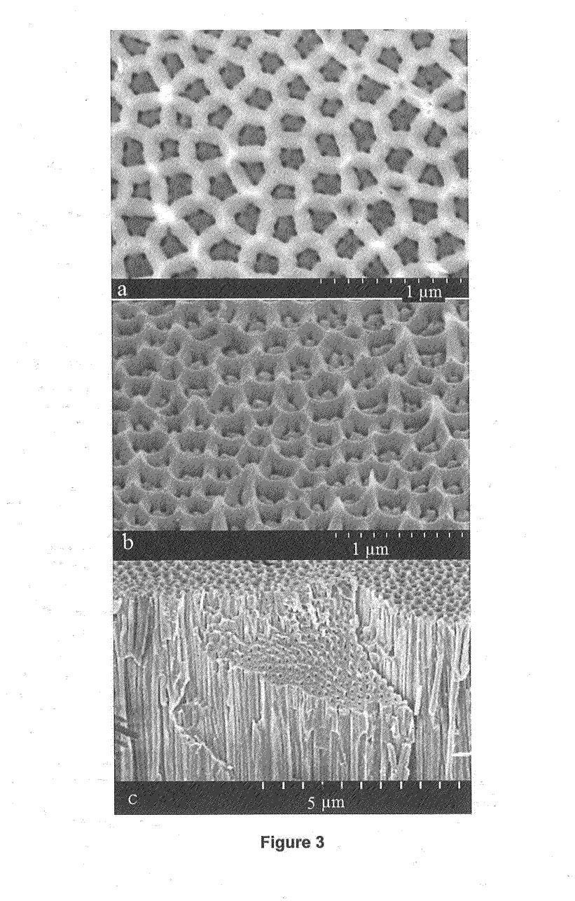

FIG. 3 provides SEM image of such a nano-porous multi-layer membrane manufactured using two steps of hard anodization as mentioned above. FIG. 3(a) depicts the surface SEM image of this membrane in which first and second layer are clearly observed. The depth of first layer is about 100 nm as shown in FIG. 3(b). In FIG. 3(c) all three layers are visible; the diagonal cut in third layer clearly shows the hexagonal arrangement of pores in this layer.

### Example 2

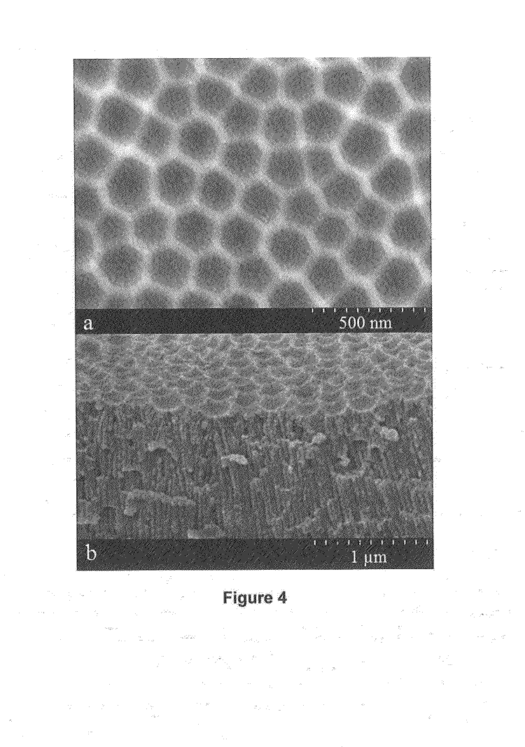

In accordance with the third embodiment the two step anodization was also carried with different electrolytes. The first step anodization was done at 126V in oxalic acid and second step in sulfuric acid at 20V. Three layered membrane was formed with first layer concave surface diameter 300 nm, second layer pore diameter about 5 nm and third layer pores diameter about 15 nm as shown in FIG. 4. Surface image depicting first and second layer is seen in FIG. 4(a). Further cross-sectional image depicting all the three layers is seen in FIG. 4(b)

### Example 3

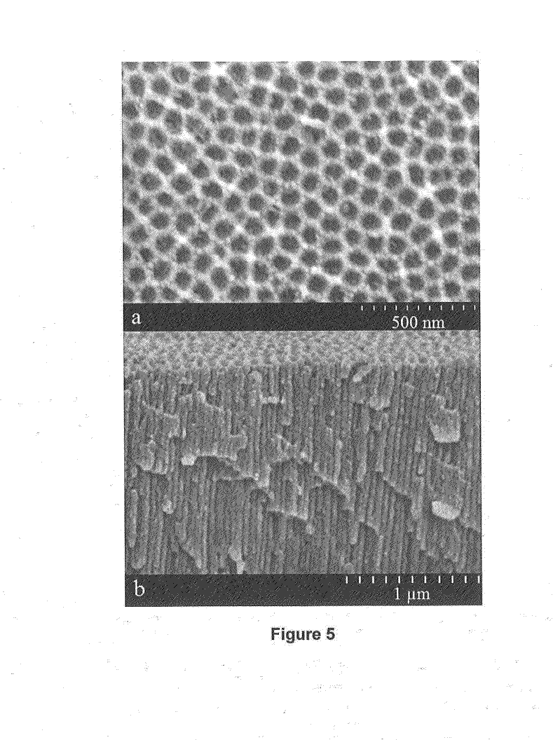

In accordance with the fourth embodiment, mild anodization is used in both the steps, however the electrolytes used are different in both the steps. The first step mild anodization is performed at 40 V in oxalic acid and second step at 20 V in sulfuric acid. Three layered membrane is formed with first layer concave surface diameter 100 nm, second layer pore diameter about 5 nm and third layer pores diameter about 15 nm as depicted in FIG. 5.

We claim:

1. A method of producing multilayer anodized aluminium oxide nano-porous membrane comprising steps of:
(i) electro-polishing of the substrate,
(ii) combination of hard and mild anodization,
(iii) etching of anodized aluminum oxide,
(iv) barrier layer removal.

2. A method of producing multilayer anodized aluminium oxide nano-porous membrane as claimed in claim 1 wherein of electro polishing of Aluminum substrate (Al) comprises steps of:
(i) placing the said Al in the mixture of perchloric acid and ethanol wherein the ratio of respective chemicals is in the range of 1:3 to 1:5 by volume wherein purity of ethanol is in the range of 99%-99.9% and that of Perchloric acid is in the range of 69-72%;
(ii) applying potential at a temperature less than 10° C. wherein the potential is in the range of 10 to 20 V;
(iii) applying potential for 3 to 10 min depending on the surface roughness.

3. A method of producing multilayer anodized aluminium oxide nano-porous membrane as claimed in claim 1 wherein the nano-porous multi-layer membrane is produced using a combination of hard and mild anodization method wherein the first step anodiation voltage is maintained and further in the second step voltage is maintained lower than that in the first step resulting in generation of plurality of pores in the each of the concave surface of the region.

4. A method of producing multilayer anodized aluminium oxide nano-porous membrane as claimed in claim 1 wherein there is progressive increase in the pore diameter towards the bottom of the membrane and further there is a substantially constant diameter of the pore.

5. A method of producing multilayer anodized aluminium oxide nano-porous membrane as claimed in claim 1 wherein first step hard anodization process comprises steps of:
(i) selecting electrolyte from either of oxalic acid, phosphoric acid, sulfuric acid and malunic acid wherein the concentration of the said acid depends on the pore size;
(ii) gradual application of voltage from 20 V up to the final voltage that is in the range of 60 to 200 V wherein process time depends on the membrane thickness, it can range from 5 minutes to 20 minutes.

6. A method of producing multilayer anodized aluminium oxide nano-porous membrane as claimed in claim 1 wherein chemical etching of the anodized aluminum oxide comprises a step of etching in chromic acid and phosphoric acid wherein the temperature is in the range of 65-80° C. wherein phosphoric acid is in the range of 6 wt % to 7 wt % and chromic acid is in the range of 2 wt % to 3 wt % wherein purity of chromic acid is 99% and purity of phosphoric acid is 85%.

7. A method of producing multilayer anodized aluminium oxide nano-porous membrane as claimed in claim 1 wherein the second step mild anodization comprises steps of:
(i) selecting electrolyte from either of oxalic acid, phosphoric acid, sulfuric acid and malunic acid wherein the concentration of the said acid depends on the pore size;
(ii) applying a constant voltage directly to the final value without gradually increasing it that is lower than that in the first step anodization wherein the said final voltage is in the range of 20 to 195 V depending on the electrolyte and pore size.

8. A method of producing multilayer anodized aluminium oxide nano-porous membrane as claimed in claim 1 wherein the barrier layer (BL) is removed using voltage pulse method comprising steps of:
(i) placing the said substrate in perchloric acid and ethanol with volume ratio in the range of 1:3 to 1:5 respectively;
(ii) applying a voltage pulse from 45 to 50 V for 3 to 5 seconds that causes to detach AAO from Al and remove BL.

9. A method of producing multilayer anodized aluminium oxide nano-porous membrane as claimed in claim 1 wherein
(i) the said first step anodization is performed at 120 to 130V in oxalic acid as electrolyte for 5 to 10 min depending on the size of the substrate;
(ii) etching is carried out in chromic acid and phosphoric acid wherein the temperature is in the range of 65-80° C.; preferably phosphoric acid is in the range 6 wt % to 7 wt % and chromic acid is in the range of 2 wt % to 3 wt % wherein preferably purity of Chromic acid is 99% and purity of phosphoric acid is 85%;
(iii) upon etching hexagonal arrangement of concave surfaces appeared on Al surface;
(iv) plurality of small pores initiated in each of the concave surface;
(v) the said second step mild anodization is performed at 40 to 45 V using the same electrolyte as used in the first step anodization
wherein
the barrier layer is removed either by chemical etching or voltage pulse detachment method wherein the chemical etching comprising steps of:
(vi) etching the substrate in saturated mercuric chloride so as to separate anodized aluminum oxide from Al;
(vii) placing of AAO in 5 wt % Phosphoric acid for about 35 to 40 min at 31° C. to 32° C. for etching of BL.
wherein
the voltage pulse detachment comprises steps of:
(viii) placing anodized aluminum substrate in Perchloric acid and ethanol with volume ratio from 1:3 to 1:5 respectively,
(ix) applying a voltage pulse from 45 to 50 V for 3 to 5 s which causes detachment of AAO from Al and remove BL.

10. A method of producing multilayer anodized aluminium oxide nano-porous membrane as claimed in claim 1 wherein
(i) the said first step anodization is performed at voltage in the range of 120 to 130V in oxalic acid as electrolyte for 5 to 10 min;
(ii) etching is carried out in chromic acid and phosphoric acid;
(iii) upon etching hexagonal arrangement of concave surfaces appeared on Al surface wherein the depth of this layer is about 100 nm;
(iv) plurality of small pores initiated in each of the concave surface;
(v) the said second step hard anodization is performed at 100 to 110V using same electrolyte as used in the first step anodization wherein average diameter of pore is 25 nm;
(vi) further, pores diameter is increased as nano-channels proceed by few nanometers wherein in third layer diameter is about 80 nm in one of the preferred variants
wherein
the barrier layer is removed either by chemical etching or voltage pulse detachment method wherein the chemical etching comprising steps of:
(vii) etching the substrate in saturated mercuric chloride so as to separate anodized aluminum oxide from Al,
(viii) placing of AAO in 5 wt % Phosphoric acid for about 35 to 40 min at 31° C. to 32° C. for etching of BL
wherein
the voltage pulse detachment comprises steps of:
(ix) placing anodized aluminum substrate in Perchloric acid and ethanol with volume ratio from 1:3 to 1:5 respectively,
(x) applying a voltage pulse from 45 to 50 V for 3 to 5 s which causes detachment of AAO from Al and remove BL.

11. A method of producing multilayer anodized aluminium oxide nano-porous membrane as claimed in claim 1 wherein the first step hard anodization is carried out at the voltage selected in the range of 120 to 130 V in oxalic acid and second step in sulfuric acid wherein voltage is selected in the range of 20 to 25 V.

12. A method of producing multilayer anodized aluminium oxide nano-porous membrane as claimed in claim 1 wherein the first step mild anodization is performed at a voltage in the range of 40 to 45V in oxalic acid and second step at a voltage selected in the range of 20 to 25 V in sulfuric acid.

13. A multilayer anodized aluminium oxide nano-porous membrane wherein a three layered membrane comprises of the first layer concave surface diameter 100 nm, second layer pore diameter about 5 nm and third layer pores diameter about 15 nm.

14. A multilayer anodized aluminium oxide nano-porous membrane wherein a three layered membrane comprises of the first layer concave surface of diameter 300 nm, second layer pore diameter 5 nm and third layer pores diameter about 15 nm.
